(19) United States
(12) Patent Application Publication
(10) Pub. No.: US 2008/0090728 A1
(43) Pub. Date: Apr. 17, 2008

(54) Method for Improving Plant Growth

(75) Inventors: Diana Rodekohr, Solingen (DE); Uwe Priesnitz, Solingen (DE); Frank Rosenfeldt, Langenfeld (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: BAYER CROPSCIENCE AG, Monheim (DE)

(21) Appl. No.: 11/568,927

(22) PCT Filed: Apr. 30, 2005
(86) PCT No.: PCT/EP05/04712

§ 371 Date: May 4, 2007

(30) Foreign Application Priority Data
May 13, 2004 (EP) 040113365.6

(51) Int. Cl. A01N 51/00; A01N 43/40; A01P 7/04; C05G 3/02; A01N 47/40

(52) U.S. Cl. 504/101; 514/229.2; 514/341; 514/342; 514/357; 514/365; 514/471

(57) ABSTRACT

The present invention relates to a method of improving the growth of plants comprising applying to said plant or the locus thereof at least one compound selected from the class of agonists and antagonists of the nicotinic acetylcholine receptors in combination with a fertilizer.

### FIELD OF THE INVENTION

The present invention relates to a method of improving the growth of plants comprising applying to said plant or the locus thereof at least one compound selected from the class of agonists and antagonists of the nicotinic acetylcholine receptors in combination with a fertilizer.

### BACKGROUND OF THE INVENTION

Certain methods of improving plant growth are described in the literature. These methods are usually based on conventional fertilising. The biological effects of those known methods are however not entirely satisfactory in the area of agriculture.

WO 01/26468 and Proceedings of the World Cotton Research Conference, Athens, Sep. 6-12, 1998, 1189-1190, disclose that certain neonicotinyles improve the growth of certain plants. This effect is also observed, while the plants are not infested by insects and/or members of the order Arcadia. Hort. Science 30(5), 1995, 997-999 discloses that—in the absence of insects—no growth effect is observed for cucumis melo L. if certain neonicotinyles, e.g. imidacloprid, are used. It is therefore unpredictable which neonicotinyle will have a growth effect on which plant.

WO 95/28370 discloses mixtures comprising a fertilizer component and an agonist or antagonist of the nicotinergic acetylcholine receptors of insects and their use for controlling insects.

WO 96/33614 relates to a method of plant growth regulation whereby a 1-phenylpyrazole is applied to a crop or a seed.

However, none of the references cited above teaches the use of a compound selected from the class of agonists and antagonists of the nicotinic acetylcholine receptors in combination with a fertilizer to obtain a growth effect.

It is also known that planting shock can occur generally when transplanting trees and in particular in the case of forest trees and/or amenity trees. One of the effects of planting shock is decreased growth and increased perishing of seedlings. Attempts are made to counteract this effect by increased fertilizing and increased watering. The results of such steps are not always satisfactory.

It is also known that unfavourable conditions of location and unfavourable climatic conditions have a negative effect on the growth of forest trees and/or amenity trees.

There is therefore still a need to improve the growth of plants, basically for obtaining an improved growth, an increased resistance and an increased vitality of said plants. There is a further need to reduce the planting shock of said plants for achieving the same results as stated above. There is a further need for the reduction of fertilizers used basically to achieve the same results as stated above by reducing the fertilizer needed.

### SUMMARY OF THE INVENTION

The present invention provides a new process and a new method of improving plant growth of plants, wherein at least one compound selected from the class of agonists and antagonists of the nicotinic acetylcholine receptors in combination with a fertilizer is applied to the plant or the locus thereof.

Further, the present invention provides a new process and a new method of improving plant growth, wherein at least one neonicotinoid compound in combination with a fertilizer is applied to the plant or the locus thereof.

Surprisingly, the growth effect of the combinations according to the invention is considerably higher than the sum of the activities of the compound selected from the class of agonists and antagonists of the nicotinic acetylcholine receptors or the fertilizer. Thus, an unforeseeable, true synergistic effect is present, and not just an addition of activities.

### DESCRIPTION OF SPECIFIC EMBODIMENTS

Preferred is a method of improving the growth of plants, wherein at least one compound selected from the class of agonists and antagonists of the nicotinic acetylcholine receptors in combination with a fertilizer is applied.

The agonists and antagonists of the nicotinic acetylcholine receptors are known compounds e.g. from the following publications: European Published Specifications Nos. 464 830, 428 941, 425 978, 386565, 383091, 375907, 364844, 315826, 259738, 254859, 235725, 212600, 192060, 163 855, 154 178, 136 636, 136 686, 303 570, 302 833, 306 696, 189 972, 455 000, 135 956, 471 372, 302 389, 428 941, 376 279, 493 369, 580 553, 649 845, 685 477, 483 055, 580 553; German Offenlegungsschriften Nos. 3 639 877, 3 712 307; Japanese Published Specifications Nos. 03 220 176, 02 207 083, 63 307 857, 63 287 764, 03 246 283, 04 9371, 03 279 359, 03 255 072, 05 118 833, 07 173 157, 08 291 171; U.S. Pat. Nos. 5,034,524, 4,948,798, 4,918,086, 5,039,686, 5,034,404, 5,532,365, 4,849,432; PCT Applications Nos. WO 91/17 659, 91/4965; French Application No. 2 611 114; Brazilian Application No. 88 03 621.

All the generic formulae and definitions described in these publications, and also the individual compounds described therein, are expressly incorporated herein by reference.

Some of these compounds are summarized under the term nitromethylenes, nitroimines or neonictinoids and related compounds. The compounds of formula (I) will be referred to as neonicotinoyles within the scope of the present invention.

Preferably, these compounds can be summarized under the formula (I)

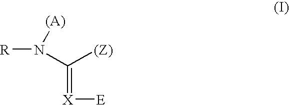

in which
R represents hydrogen or represents optionally substituted radicals selected from the group consisting of acyl, alkyl, aryl, heterocyclyl, heteroaryl, heterocyclylalkyl, aralkyl or heteroarylalkyl;
A represents a monofunctional group selected from the group consisting of hydrogen, acyl, alkyl, aryl or represents a bifunctional group which is linked to the radical Z;
E represents an electron-withdrawing radical;
X represents the radicals -CH═ or ═N-, where the radical -CH═ may be linked to the radical Z instead of an H atom;
z represents a monofunctional group selected from the group consisting of alkyl, -O-R, -S-R,

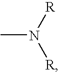

where the radicals R are identical or different and are as defined above,
or represents a bifunctional group which is linked to the radical A or the radical X.

Particular preference is given to compounds of the formula (1) in which the radicals have the following meaning:
R represents hydrogen and represents optionally substituted radicals selected from the group consisting of acyl, alkyl, aryl, aralkyl, heterocyclylalkyl, heteroaryl, heteroarylalkyl.

Examples of acyl radicals are formyl, alkylcarbonyl, arylcarbonyl, alkylsulphonyl, arylsulphonyl, (alkyl-)-(aryl-)-phosphoryl, which may themselves be substituted.

Examples of alkyl are C₁-C₁₀-alkyl, in particular C₁-C₄-alkyl, specifically methyl, ethyl, i-propyl, sec- or t-butyl, which may themselves be substituted.

Examples of aryl are phenyl, naphthyl, in particular phenyl.

Examples of aralkyl are phenylmethyl, phenethyl.

An example of heterocyclylalkyl is the radical

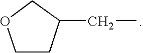

Examples of heteroaryl are heteroaryl having up to 10 ring atoms and N, O, S, in particular N, as heteroatoms. Specific examples are thienyl, furyl, thiazolyl, imidazolyl, pyridyl, benzothiazolyl, pyridazinyl.

Examples of heteroarylalkyl are heteroarylmethyl, heteroarylethyl having up to 6 ring atoms and N, O, S, in particular N, as heteroatoms, in particular optionally substituted heteroaryl as defined under heteroaryl.

Substituents which may be mentioned by way of example and by way of preference are:

alkyl having preferably 1 to 4, in particular 1 or 2, carbon atoms, such as methyl, ethyl, n- and i-propyl and n-, i- and t-butyl; alkoxy having preferably 1 to 4, in particular 1 or 2, carbon atoms, such as methoxy, ethoxy, n- and i-propyloxy and n-, i- and t-butyloxy; alkylthio having preferably 1 to 4, in particular 1 or 2, carbon atoms, such as methylthio, ethylthio, n- and i-propylthio and n-, i- and t-butylthio; halogenoalkyl having preferably 1 to 4, in 20 particular 1 or 2, carbon atoms and preferably 1 to 5, in particular 1 to 3, halogen atoms, the halogen atoms being identical or different, and preferred halogen atoms being fluorine, chlorine or bromine, in particular fluorine, such as trifluoromethyl, hydroxyl; halogen, preferably fluorine, chlorine, bromine and iodine, in particular fluorine, chlorine and bromine, cyano; nitro; amino; monoalkyl- and dialkylamino having preferably 1 to 4, in particular 1 or 2, carbon atoms per alkyl group, such as methylamino, methylethylamino n- and i-propylamino and methyl-n-butylamino; carboxyl; carbalkoxy having preferably 2 to 4, in particular 2 or 3, carbon atoms, such as carbomethoxy and carboethoxy; sulpho (SO₃H); alkylsulphonyl having preferably 1 to 4, in particular 1 or 2, carbon atoms, such as methylsulphonyl and ethylsulphonyl; arylsulphonyl having preferably 6 or 10 arylcarbon atoms, such as phenylsulphonyl, and also heteroarylamino and heteroarylalkylamino such as chloropyridylamino and chloropyridylmethylamino.
A represents hydrogen or represents an optionally substituted radical selected from the group consisting of acyl, alkyl, aryl, which are preferably as defined under R, A furthermore represents a bifunctional group. Examples include optionally substituted alkylene having 1 to 4, in particular 1 to 2, C atoms, examples of substitutents being the substituents which have been mentioned further above (and where the alkylene groups may be interrupted by heteroatoms from the group consisting of N, O, S).
A and Z together with the atoms to which they are attached may form a saturated or unsaturated heterocyclic ring. The heterocyclic ring may contain a further 1 or 2 identical or different heteroatoms and/or heterogroups. Preferred heteroatoms are oxygen, sulphur or nitrogen, and preferred heterogroups are N-alkyl, where the alkyl of the N-alkyl group contains preferably 1 to 4, in particular 1 or 2, carbon atoms. Examples of alkyl include methyl, ethyl, n- and i-propyl and n-, i- and t-butyl. The heterocyclic ring contains 5 to 7, preferably 5 or 6 ring members.

Examples of compounds of the formula (1) in which R and Z together with the atoms to which they are attached form a ring include the following:

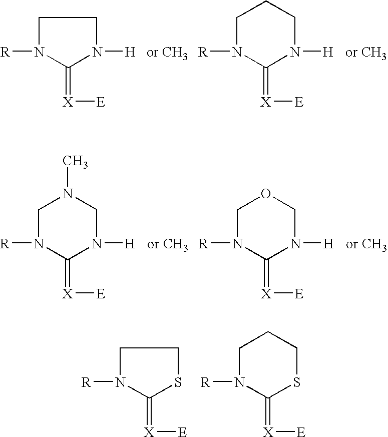

in which

E, R and X are each as defined above and further below.
E represents an electron-withdrawing radical, specific examples being NO₂, CN, halogenoalkylcarbonyl such as halogeno-C₁-C₄-alkylcarbonyl, for example COCF₃, alkylsulphonyl (for example SO₂—CH₃), halogenoalkylsulphonyl (for example SO₂CF₃) and with particular preference NO₂ or CN.
X represents -CH═ or -N═.
Z represents an optionally substituted radical selected from the group consisting of alkyl, -OR, -SR, -NRR, where R and the substituents are preferably as defined above.
Z may, in addition to the ring mentioned above, together with the atom to which it is attached and the radical

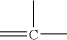

instead of X, form a saturated or unsaturated heterocyclic ring. The heterocyclic ring may contain a further 1 or 2 identical or different heteroatoms and/or heterogroups. Preferred heteroatoms are oxygen, sulphur or nitrogen and preferred heterogroups are N-alkyl, where the alkyl or N-alkyl group contains preferably 1 to 4, preferably 1 or 2, carbon atoms. Examples of alkyl include methyl, ethyl, n- and i-propyl and n-, i- and t-butyl. The heterocyclic ring contains 5 to 7, preferably 5 or 6, ring members. Examples of the heterocyclic ring include pyrrolidine, piperidine, piperazine, hexamethyleneimine, morpholine and N-methylpiperazine.

The agonists and antagonists of the nicotinic acetylcholine receptors are particularly preferably compounds of the formula (I) in which
R represents

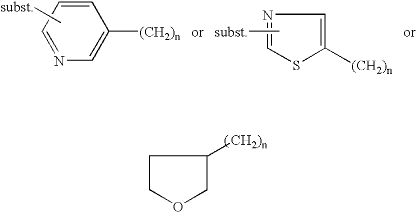

where
n represents 0, 1 or 2, and preferably represents 1,
subst. represents one of the substituents mentioned above, especially halogen, in particular chlorine, and A, Z, X and E are as defined above.
R represents in particular

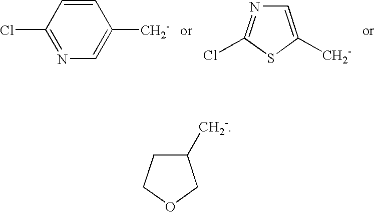

The following compounds are specific examples:

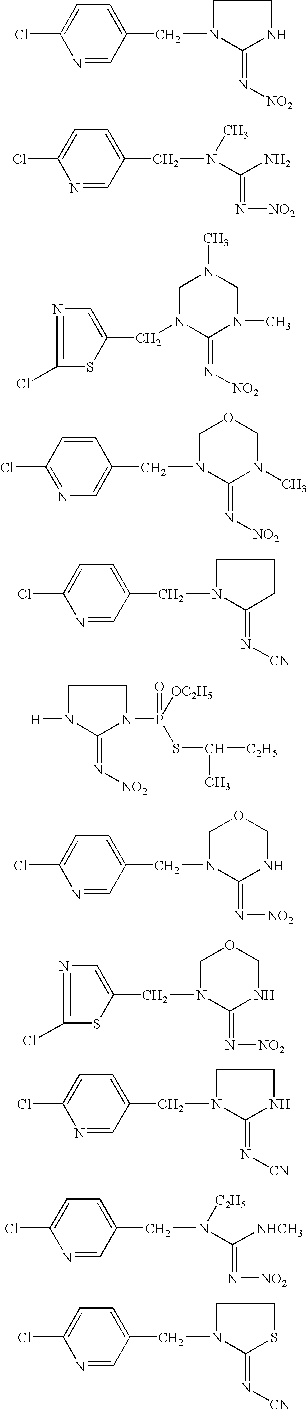

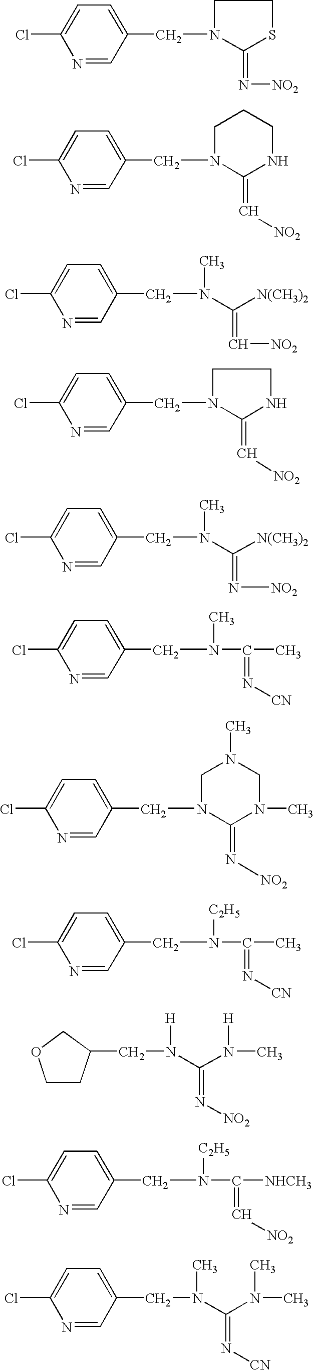

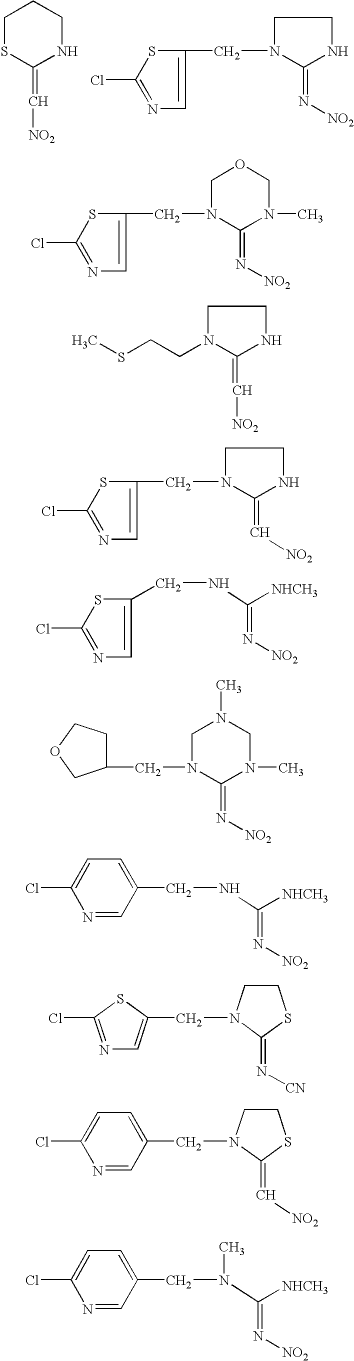

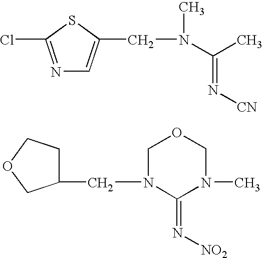

Very particularly preferred agonists and antagonists of the nicotinic acetylcholine receptors are compounds of the following formulae:

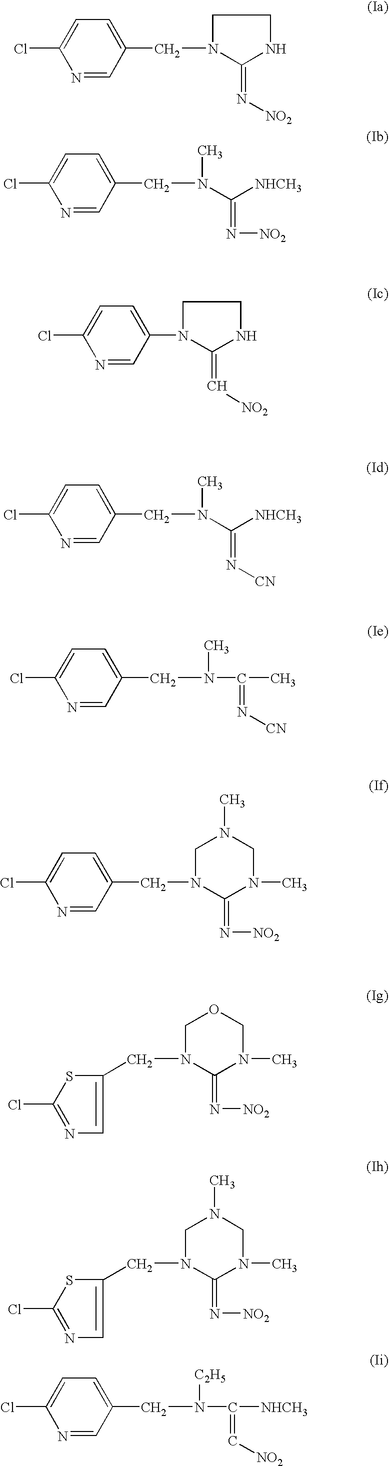

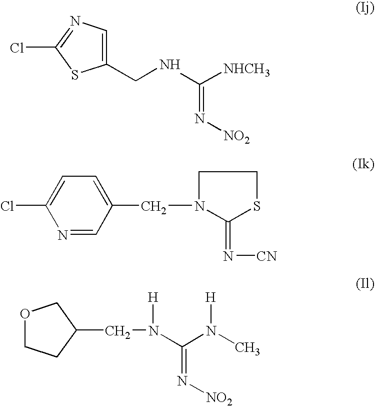

Very particular preference is given to the compound of formula (Ia) (Imidacloprid).

Very particular preference is given to the compound of formula (Ie) (Acetamiprid).

Very particular preference is given to the compound of formula (Ig) (Thiamethoxam).

Very particular preference is given to the compound of formula (Ii) (Nitempyram).

Very particular preference is given to the compound of formula (Ij) (Clothianidin).

Very particular preference is given to the compound of formula (Ik) (Thiacloprid).

Very particular preference is given to the compound of formula (Il) (Dinotefuran).

The compounds of the formula (I) may form tautomers. Accordingly, hereinbefore and hereinafter, where appropriate the compound compounds (I) are to be understood to include corresponding tautomers, even if the latter are not specifically mentioned in each case.

The compounds of the formula (I) are capable of forming acid addition salts. Those salts are formed, for example, with strong inorganic acids, such as mineral acids, for example perchloric acid, sulfuric acid, nitric acid, nitrous acid, a phosphoric acid or a hydrohalic acid, with strong organic carboxylic acids, such as unsubstituted or substituted, for example halo-substituted, C1-C4alkanecarboxylic acids, for example acetic acid, saturated or unsaturated dicarboxylic acids, for example oxalic, malonic, succinic, maleic, fumaric or phthalic acid, hydroxycarboxylic acids, for example ascorbic, lactic, malic, tartaric or citric acid, or benzoic acid, or with organic sulfonic acids, such as unsubstituted or substituted, for example halo-substituted, C1-C4alkane- or aryl-sulfonic acids, for example methane- or p-toluene-sulfonic acid. Furthermore, compounds of formula (I) having at least one acidic group are capable of forming salts with bases.

Suitable salts with bases are, for example, metal salts, such as alkali metal or alkaline earth metal salts, for example sodium, potassium or magnesium salts, or salts with ammonia or an organic amine, such as morpholine, piperidine, pyrrolidine, a mono-, di- or tri-lower alkylamine, for example ethyl-, diethyl-, triethyl- or dimethyl-propyl-amine, or a mono-, di- or tri-hydroxy-lower alkylamine, for example mono-, di- or tri-ethanolamine.

In addition, corresponding internal salts may also be formed. Preference is given within the scope of the invention to agrochemically advantageous salts.

In view of the close relationship between the compounds of formula (I) in free form and in the form of their salts, any reference hereinbefore or hereinafter to the free compounds of formula (I) or to their respective salts is to be understood as including also the corresponding salts or the free compounds of formula (I), where appropriate and expedient. The same applies in the case of tautomers of compounds of formula (I) and the salts thereof. The free form is generally preferred in each case.

Fertilizers which may be used are organic and inorganic nitrogen-containing compounds such as urea, urea- formaldehyde condensation products, amino acids, ammonium salts and nitrates, and also potassium salts (preferably chlorides, sulphates, nitrates) and phosphoric acid and/or salts of phosphoric acids (preferably potassium salts and ammonium salts). The fertilizers may also contain salts of micronutrients (preferably manganese, magnesium, iron, boron, copper, zinc, molybdenum and cobalt) and phytohormones (e.g. vitamin B1 and indole-III-acetic acid). The commercially available complete fertilizers are preferably employed.

The principal fertilizer constituents, nitrogen, potassium and phosphorus, can be varied within wide limits. It is conventional to use contents of from 1 to 30% of nitrogen (preferably from 5 to 20%), from 1 to 20% of potassium (preferably from 3 to 15%) and from 1 to 20% of phosphorus (preferably from 3 to 10%). The contents of microelements are usually in the ppm range, preferably from 1 to 1000 ppm.

Surprisingly, it has been found that the application of the compounds of the formula (1) in combination with fertilizers as defined above to the plants or the locus thereof results in a quite unexpectedly enhanced plant growth.

It has flow been found, that the action of the compounds of the formula (I) goes far beyond their well-known pesticidal action. It has been shown, that the compounds of the formula (I) exhibit an action termed plant growth in the frame of the instant invention.

Under the term plant growth there are understood various sorts of improvements of plants which are not connected to the control of pests with the said compound (I). For example such advantageous properties that may be mentioned are improved crop characteristics including: emergence, more developed root system, tillering increase, increase in plant height, bigger leaf blade, less dead basal leaves, stronger tillers, more productive tillers, greener leaf colour, less fertilizers needed, less seeds needed, earlier flowering, less plant verse (lodging), increased shoot growth, improved plant vigour, and early germination, drought resistance, wood production, chlorophyll content, stress tolerance; or any other advantages familiar to a person skilled in the art.

It has been shown, that compounds of the instant formula (I) have a good effect on the plant growth. As a rule, a good effect means at least 10% earlier emergence, crop yields, more developed root system, increase in plant height, bigger leaf blade, less fertilizers needed, less seeds needed, increased shoot growth, improved plant vigor etc. A further aspect of the invention is a method of using a agonists and antagonists of the nicotinic acetylcholine receptors in a method for improving the growth of plants.

Especially preferred is the use of the said agonists and antagonists of the nicotinic acetylcholine receptors in a method for the improvement of the growth plants which are essentially free of insects and representatives of the order Acarina.

A further aspect of the invention is the use of an agonists and antagonists of the nicotinic acetylcholine receptors in a method for improving the growth of plants.

Still a further aspect of the invention is a method of using a composition comprising an agonists and antagonists of the nicotinic acetylcholine receptors in a method for improving the growth of plants.

Still a further aspect of the invention is a method of using a composition comprising an agonists and antagonists of the nicotinic acetylcholine receptors at same time a young plant is planted.

Still a further aspect of the invention is a method of applying a composition comprising an agonists and antagonists of the nicotinic acetylcholine receptors to the seedling of a forest tree or a amenity tree.

Preferably, plants are selected from the group of crop plants, ornamental plants, amenity trees and forest trees.

Forest trees are trees used for the production of wood, pulp, paper and products made of the parts of trees.

Amenity trees are trees planted on public of private areas for ornamental and/or amenity reasons.

rye, oats, rice, maize and sorghum; beet, such as sugar beet and fodder beet; fruit, for example pomes, stone fruit and soft fruit, such as apples, pears, plums, peaches, almonds, cherries and berries, e.g. strawberries, raspberries and blackberries; leguminous fruits, such as beans, lentils, peas and soybeans; oil plants, such as rape, mustard, poppy, olives, sunflowers, coconut, castor oil plants, cocoa beans and groundnuts; cucurbitaceae, such as marrows, cucumbers and melons; fiber plants, such as cotton, flax, hemp and jute; citrus fruit, such as oranges, lemons, grapefruit and mandarins; vegetables, such as spinach, lettuce, asparagus, cabbages, carrots, onions, tomatoes, potatoes and paprika; lauraceae, such as avocados, cinnamon and camphor-, and also tobacco, nuts, coffee, aubergines, sugar cane, tea, pepper, vines, hops, bananas, natural rubber plants and ornamentals; especially rice, beans, soybeans, rape and potatoes.

Trees which can be improved according to the present invention include: Albies sp., Eucalyptus sp., Picea sp., Pinus sp., Aesculus sp., Platanus sp., Tilia sp., Acer sp, Tsuga sp, Fraxinus sp, Sorbus sp., Betula sp., crataegus sp., Ulmus sp., Quercus sp., Salix sp., Populus sp.

Preferred trees which can be improved according to the present method include: From the species of Aesculus: A. hippocastanum, A. pariflora, A. carnea; From the species of Platanus: P. aceriflora, P. occidentalis, P. racemosa; From the species of Picea: P. abies; From the species of Pinus: P. radiate, P. ponderosa, P. contorta, P. sylvestre, P. elliottii, P. montecola, P. albicaulis, P. resinosa, P. palustris, P. taeda, P. flexilis, P. jeffregi, P. baksiana, P. strobes; From the species of Eucalyptus: E. grandis, E. globulus, E. camadentis, E. nitens, E. obliqua, E. regnans, E. pilularus.

Very preferred trees which can be improved according to the present invention include: From the species of Pinus: P. radiate, P. ponderosa, P. contorta, P. sylvestre, P. strobes; From the species of Eucalyptus: E. grandis, E. globulus, E. camadentis

Very preferred trees which can be improved according to the present invention also include: Horse Chestnut, Plane tree, lime tree, maple tree.

The invention accordingly relates also to compositions comprising at least one compound selected from the class of agonists and antagonists of the nicotinic acetylcholine receptors in combination with a fertilizer and the use of said compositions, such as emulsifiable concentrates, suspension concentrates, directly sprayable or dilutable solutions, coatable pastes, dilute emulsions, wettable powders, soluble powders, dispersible powders, wettable powders, dusts, shaped articles, granules or encapsulations in polymeric substances, which comprise at least one of the compounds according to the invention, the type of formulation being chosen in accordance with the intended objectives and the prevailing circumstances.

Preferred compositions are granules or encapsulations in polymeric substances, which comprise at least one compound selected from the class of agonists and antagonists of the nicotinic acetylcholine receptors in combination with a fertilizer.

The compounds of the formula (I) are used in those compositions in pure form, a solid the compounds of the formula (I) being used, for example, in a specific particle size, or, preferably, together with at least one of the adjuvants customary in formulation technology, such as extenders, e.g. solvents or solid carriers, or surface-active compounds (surfactants).

Suitable formulation adjuvants are, for example, solid carriers, solvents, stabilisers, slow-release adjuvants, dyes and optionally surface-active substances (surfactants). Suitable carriers and adjuvants in this case include all substances customarily used in crop protection products, especially in products for controlling snails and slugs. Suitable adjuvants, such as solvents, solid carriers, surface-active compounds, non-ionic surfactants, cationic surfactants, anionic surfactants and further adjuvants in the compositions used in accordance with the invention are, for example, the same as those described in EP-A-736 252; are fully incorporated by reference herein for their disclosure relating to useful formulation adjuvants.

The compositions usually contain from 0.1 to 99%, especially from 0.1 to 95%, of a compound of the formula (I) and from 1 to 99.9%, especially from 5 to 99. of at least one solid or liquid adjuvant, it generally being possible for from 0 to 25 especially from 0.1 to 20%, of the composition to be surfactants (in each case percentages are by weight). Whereas commercial products will preferably be formulated as concentrates, the end user will normally employ dilute formulations which have considerably lower concentrations of one or more compounds of the formula (I).

Preferred formulations have especially the following composition (% =percent by weight):

Emulsifiable concentrates: active ingredient: 1 to 90%, preferably 5 to 20% surface-active agent: 1 to 30 preferably 10 to 20% liquid carrier: 5 to 94 preferably 70 to 85%

Dusts: active ingredient: 0.1 to 10%, preferably 0.1 to 1% solid carrier: 99.9 to 90%, preferably 99.9 to 99%

Suspension concentrates: active ingredient: 5 to 75%, preferably 10 to 50% water: 94 to 24%, preferably 88 to 30% surface-active agent: 1 to 40%, preferably 2 to 30%

Wettable powders: active ingredient: 0.5 to 90%, preferably 1 to 80% surface-active agent: 0.5 to 20%, preferably 1 to 15% solid carrier: 5 to 95%, preferably 15 to 90%

Granules: active ingredient: 0.5 to 30%, preferably 3 to 15% solid carrier: 99.5 to 70%, preferably 97 to 85%

Injection solution: active ingredient: 0.1 to 10%, preferably 0.5 to 5% non-ionic surfactant: 0.1 to 30 preferably 0.5 to 10% mixture of ethanol and propylene glycol: 60 to 99 preferably 85 to 90%

Injection suspension (aqueous or oily): active ingredient: 0.1 to 20 preferably 1 to 10% non-ionic surfactant: 0.1 to 20 preferably 1 to 10% water or vegetable oil: 60 to 99 preferably 85 to 95%

The compositions according to the invention are prepared in known manner: in the absence of adjuvants, for example, by grinding, sieving and/or compressing a solid compound of the formula (I), for example to a specific particle size, and, in the presence of at least one adjuvant, for example, by intimately mixing and/or grinding the compound of the formula (1) with the adjuvant(s). The invention relates also to those methods of preparing the compositions according to the invention and to the use of compounds I in the preparation of such compositions.

The invention relates also to the methods of applying the compositions of the type mentioned, such as spraying, atomising, dusting, coating, dressing, scattering or pouring, which are chosen in accordance with the intended objectives and the prevailing circumstances, and to the use of the compositions for the improvement of the plants of the type mentioned. Typical rates of concentration are from 0.1 to 1000 ppm, preferably from 0.1 to 500 ppm, of compound of the formula (1). The rates of application per hectare are generally from 1 to 2000 g of compound of the formula (I) per hectare, especially from 1 to 1000 g/ha, preferably from 5 to 600 g/ha.

A preferred method of application is application to the leaves of the plants (foliar application), the frequency and rate of application depending on the desired improvement of the crop plant in question. The compound of the formula (I) may, however, also penetrate the plants through the root system (systemic action) as a result of impregnation of the locus of the plant with a liquid formulation or by incorporation of the compound of the formula (I) in solid form, for example in the form of granules, in the locus of the plant, for example in the soil (soil application).

In one embodiment, commercial products will preferably be formulated as concentrates whereas the end user will normally use dilute formulations.

In a further embodiment, commercial products will preferably be formulated as granules or shaped articles such as sticks, plates tablets.

The compositions according to the invention are also suitable for the treatment of plant propagation material, including genetically modified propagation material, e.g. seed, such as fruit, tubers or grains, or plant cuttings, The propagation material may be treated with the composition before planting, for example seed may be dressed before sowing. The compounds according to the invention may also be applied to seed grains (coating) either by impregnating the grains with a liquid formulation or by coating them with a solid formulation. The composition may also be applied to the planting site when the propagation material is being planted, for example may be applied to the seed furrow during sowing. The invention relates also to that method of treating plant propagation material and to the plant propagation material so treated.

The compounds of formula (I) are normally applied to plant propagation material in the form of compositions, but also can be applied to the seed or to the locus of propagation thereof (such as a furrow), simultaneously or in succession, with further compounds.

These further compounds can be fertilizers or micronutrient donors or other preparations that influence plant growth. They can also be selective pesticides or mixtures of several of these preparations, if desired together with further carriers, surfactants or application-promoting adjuvants customarily employed in the art of formulation.

In connection with the treatment of plant propagation material, favourable rates of application are in general 0.0005 to not more than 1 kg, in particular 0.01-0.8 kg, more particularly 0.1-0.5 kg of one or more compounds selected from the group of agonists and antagonists of the nicotinic acetylcholine receptors per 100 kg of material to be protected. However, the application conditions depend essentially on the nature (surface area, consistency, moisture content) of the material and on its environmental factors. Accordingly, within these ranges, those skilled in the art will choose, on the basis of their general body of knowledge and, where appropriate, a few experiments, doses which are non-phytotoxic but effective for improving the plant growth.

The techniques of seed treatment application are well known to those skilled in the art, and they may be used readily in the context of the present invention. The compounds of the formula (I) can be formulated and applied as a slurry, a solid seed coating, a soak, or as a dust on the surface of the seed. There also may be mentioned, e.g., film-coating or encapsulation. The coating processes are well known in the art, and employ, for seeds, the techniques of film-coating or encapsulation, or for the other multiplication products, the techniques of immersion. Needless to say, the method of application of the compounds to the seed may be varied and the invention is intended to include any technique which is to be used.

A preferred method of applying the mixture to the plant propagation material according to the invention consists in spraying or wetting the plant propagation material with a liquid preparation, or mixing the plant material with a solid preparation of the compounds of the formula (I).

The compounds of this invention may be formulated or mixed in the seed treating tank or combined on the seed by overcoating with other seed treating agents. The agents to be mixed with the compounds of this invention may be for the control of pests, or further modification of growth, nutrition, or for the control of plant diseases.

Adhesives which may be mentioned are tackifiers such as carboxymethylcellulose, natural and synthetic polymers in the form of powders, granules or latices, polyvinylpyrrolidone, vinyl-pyrrolidone-styrene copolymers, vinylpyrrolidon-vinylacetat copolymers, polyethyleneglycols or inorganic adhesives such as gypsum or cement. They are present in the mixture in concentrations of from 1 to 30% by weight, preferably from 2 to 20% by weight.

Suitable solid carrier materials are, for example, natural ground minerals such as kaolins, aluminas, talc, chalk, quartz, attapulgite, montmorillonite or diatomaceous earth and synthetic ground minerals such as highly dispersed silicic acid, aluminum oxide and silicates, in addition calcium-phosphates and calcium-hydrogen- phosphates. Suitable solid carrier materials for granules are, for example, crushed and fractionated natural minerals such as calcite, marble, pumice, sepiolite, dolomite and synthetic granules of inorganic and organic ground materials, and also granules of organic material such as sawdust, coconut husks, corn cobs and tobacco stalks.

Further auxiliaries for the preparation of the mixtures according to the invention are disintegrants and surfactants.

Disintegrants are employed in order to promote the release of the active substance in the soil. Corn starch, crosslinked polyvinylpyrrolidone and specific celluloses are used individually or in combination. The disintegrants are present in concentrations of from 1 to 20% by weight, preferably from 3 to 10% by weight.

Surfactants are employed in order to improve the biological activity of the active substance by solubilization; their content is between 1 to 10% by weight, preferably from 2 to 5% by weight. Nonionic surfactants of the alkyl-aryl-ethoxylate type are appropriate.

In summary, it is seen that this invention provides a new method for improving the plant growth. Variations may be made in proportions, procedures and materials without departing from the scope of the invention as defined by the following claims.

The synergistic effect is particularly pronounced when the active compounds in the active compound combinations according to the invention are present in certain weight ratios. However, the weight ratios of the active compounds in the active compound combinations can be varied within a relatively wide range.

The good growth effect of combinations according to the invention is evident from the examples below. While the individual active compounds exhibit weaknesses with regard to the growth effect, the combinations have an activity which exceeds the sum of individual activities.

A synergistic effect is always present when the growth effect of the combinations according to the invention exceed the total of the activities of the active compounds when applied individually. The expected activity for a given combination of two active compounds can be calculated as follows (cf. Colby, S.R., “Calculating Synergistic and Antagonistic Responses of Herbicide Combinations”, Weeds 15, (1967), 20-22):

If
X is the growth effect when applying one compound selected from the class of agonists and antagonists of the nicotinic acetylcholine receptors at an application rate of m g/ha,
Y is the growth effect when applying fertilizer at an application rate of n g/ha and
E is the efficacy when applying the combination of A and B at an application rate of m and n g/ha, then

$$E = X + Y - \frac{X \cdot Y}{100}$$

The efficacy is calculated in %. 0% is an efficacy which corresponds to that of the control. If the actual growth effect exceeds the calculated value, then the activity of the combination is super additive, i.e. a synergistic effect exists. In this case, the efficacy which was actually observed must be greater than the value for the expected efficacy (E) calculated from the abovementioned formula.

The following examples are intended to illustrate and not to limit the present invention.

### USE EXAMPLES

The trial was established using a Latin square design (4 treatments with 4 replications each) with 49 ligneous trees per plot for a total of 784 trees in the trial.

Trees: Eucalyptus seedlings (E. globulus)

The four treatments used were

1) control (nil treatment)

2) fertilizer only

3) insecticide (i.e. imidacloprid) only

4) insecticide (i.e. imidacloprid) plus fertilizer

Bonitation of insect infestation and measurement of the height of the treated trees was done 7 months and 12 months after the trial has been started (start of trial: August 2003, bonitations: March 2004 and August 2004)

### Results

All results are statistically evaluated having a significance level of 5% . Besides the mean value comparison the Fisher's PLSD test has been applied.

TABLE 1
Bonitation March 2004

| | | Height | Calculated | Average | Efficacy | Calculated |
|---|---|---|---|---|---|---|
| | Average | of tree | height of tree | defoliation | according | efficacy |
| | height | (% of | according to | by insect | to Abbott | according to |
| Treatment | (cm) | control) | Colby (%) | damage (%) | (%) | Colby (%) |
| control | 75 | 100 | | 63 | 0 | |
| fertilizer only | 85 | 113 | | 60 | 5 | |
| imidacloprid only | 86 | 115 | | 18 | 71 | |
| imidacloprid plus | 98 | 131 | 98.05 | 8 | 87 | 72.45 |
| fertilizer | | | | | | |

TABLE 2
Bonitation August 2004

| | | Height | Calculated | Average | Efficacy | Calculated |
|---|---|---|---|---|---|---|
| | Average | of tree | height of tree | defoliation | according | efficacy |
| | height | (% of | according to | by insect | to Abbott | according to |
| Treatment | (cm) | control) | Colby (%) | damage (%) | (%) | Colby (%) |
| control | 120 | 100 | | 100 | 0 | |
| fertilizer only | 122 | 102 | | 100 | 0 | |
| imidacloprid only | 125 | 104 | | 60 | 40 | |
| imidacloprid plus | 142 | 118 | 94.5 | 53 | 47 | 40 |
| fertilizer | | | | | | |

1. A process for improving the growth of a plants plant comprising applying to said plant, or locus thereof, at least one compound selected from the class of agonists and antagonists of the nicotinic acetylcholine receptors, in combination with a fertilizer.

2. The process according to claim 1, wherein said at least one compound is a neonicotinoid.

3. The process according to claim 1, wherein said at least one compound is Imidacloprid.

4. The process according to claim 1, wherein said at least one compound is Acetamiprid.

5. The process according to claim 1, wherein said at least one compound is Thiamethoxam.

6. The process according to claim 1, wherein said at least one compound is Nitempyram.

7. The process according to claim 1, wherein said at least one compound is Clothianidin.

8. The process according to claim 1, wherein said at least one compound is Thiacloprid.

9. The process according to claim 1, wherein said at least one compound is Dinotefuran.

10. The process according to claim 1, wherein said at least one compound is applied to the plant or locus thereof at the time of planting.

11. A for improving the growth of a plant, comprising applying to said plant at least one compound selected from the class of agonists and antagonists of the nicotinic acetylcholine receptors.

12.-14. (canceled)

15. The process according to claim 1, wherein the plant is selected from the group consisting of crop plants, ornamental plants, amenity trees and Forest trees.

16. The process according to claim 2, wherein said neonicotinoid is applied in a composition comprising 0.1 to 99% of said neonicotinoid, 1 to 99% of at least one adjuvant and 0 to 25% of a surfactant.

17. The process according to claim 16, wherein said composition comprises 0.1 to 95% of said neonicotinoid, 5 to 99% of at least one adjuvant and 0.1 to 20% of a surfactant.

18. The process according to claim 1, wherein said at least one compound is applied to the plant.

19. The process according to claim 1, wherein said at least one compound is applied to the locus of the plant.

20. The process according to claim 1, wherein said at least one compound is applied to at least one leaf of the plant.

21. The process according to claim 1, wherein said at least one compound is applied in a composition formulated as a concentrate.

22. The process according to claim 1, wherein said at least one compound is applied in a composition further comprising one or more adjuvants selected from the group consisting of fertilizers, pesticides, carriers, and surfactants.
